(19) United States
(12) Patent Application Publication
(10) Pub. No.: US 2023/0296519 A1
(43) Pub. Date: Sep. 21, 2023

(54) Autofluorescence-Based Targeting of Pathologically/Diagnostically Relevant Tissue Regions for Efficient and Accurate Omics Profiling

(71) Applicant: CytoVeris Inc., Farmington, CT (US)

(72) Inventor: Alan Kersey, South Glastonbury, CT (US)

(21) Appl. No.: 18/122,544

(22) Filed: Mar. 16, 2023

Related U.S. Application Data
(60) Provisional application No. 63/320,520, filed on Mar. 16, 2022.

(51) Int. Cl. G01N 21/64; G01N 1/28

(52) U.S. Cl. CPC G01N 21/6458; G01N 1/2813; G01N 21/6486; G01N 2201/126

(57) ABSTRACT

A method of analyzing a tissue specimen is provided. The method includes imaging a tissue specimen to produce autofluorescence images acquired at different excitation and emission wavelengths, and/or reflectance images, using data produced during the imaging to identify one or more regions of interest within the tissue specimen, and performing an omics profiling on the identified one or more regions of interest within the tissue specimen to produce information relating to the tissue specimen.

This application claims priority to U.S. Patent Appln. No. 63/320,520 filed Mar. 16, 2022, which is hereby incorporated by reference in its entirety.

### BACKGROUND OF THE INVENTION

### 1. Technical Field

The present disclosure relates to devices and methods for ex-vivo tissue analysis in general, and the devices and methods for analyzing ex-vivo tissue specimens using omics technologies in particular.

### 2. Background Information

Omics technologies are identified as high-throughput biochemical assays that measure a comprehensive, or global, assessment of a set of molecules from a biological sample. For instance, genomics interrogates DNA, transcriptomics measures transcripts, and proteomics and metabolomics quantify proteins and metabolites, respectively. Cancer is a multifactorial disorder and molecular alterations during tumorigenesis take place at multiple levels including genome, epigenome, transcriptome, proteome, and metabolome. Single OMICS approaches such as identifying cancer-specific mutations and molecular subtyping of tumors based on protein/gene expression have been useful in diagnostic/therapeutic/prognostic decision-making. However, they often do not provide the complete picture of the molecular mechanism and cancer-specific hallmarks, and therefore, the multi-OMICS strategies were developed to investigate tumor tissue/cancer cells in multiple dimensions. The analysis of bulk tumor tissue is a conventional approach to profiling tumor-associated proteins/genes and the omics approaches related to bulk tissue only capture the average properties of the constituents' cells and do not accurately reflect the attributes of individual cells. Single-cell omics on the other hand characterize each individual cell and enable the discovery and classification of previously unknown cell states. However, their speed is often limited owing to microscopic resolution and individual cells are taken out of their subcellular context or neighborhood information thereby providing a limited/negligible view of the tissue microenvironment.

Spatial omics is an emerging approach that combines molecular analysis with spatial information with single-cell resolution and provides an important understanding of cellular organizations and interactions within a tissue of interest. For instance, the spatial genomic information not only encodes cell states but can also assess cell neighborhood information and interactions. The ability to survey global gene expression patterns and molecular signatures are associated with histopathological features and have application in the analysis of disease including cancer.

There are two main issues in using the tissue-level omics approaches. First, the smaller probe area makes it difficult to profile the entire tissue sections in a timely fashion. Second, owing to cellular heterogeneity, the presence of non-neoplastic cells in the neoplasm obscures neoplasm-specific gene/protein expression patterns. Therefore, it is important to choose and specimen tissue regions with high neoplastic cellularity to minimize the confounding contribution from non-neoplastic cells. This is especially true for a neoplasm that displays low neoplastic cellularity and high tissue inhomogeneity. While the latter is not applicable for single-cell omics and spatial omics approaches, owing to the microscopic resolution, sampling the entire tissue region remains a challenge and consequently there is a need for identifying pathologically relevant regions or distinct regions to increase the throughput of the sampling.

### SUMMARY

According to an aspect of the present disclosure, a method of analyzing a tissue specimen is provided. The method includes imaging a tissue specimen to produce autofluorescence images acquired at different excitation and emission wavelengths, and/or reflectance images, using data produced during the imaging to identify one or more regions of interest within the tissue specimen, and performing an omics profiling on the identified one or more regions of interest within the tissue specimen to produce information relating to the tissue specimen.

In any of the aspects or embodiments described above and herein, the omics profiling may utilize at least one of genomics or transcriptomics.

In any of the aspects or embodiments described above and herein, the omics profiling may utilize at least one of proteomics or metabolomics.

In any of the aspects or embodiments described above and herein, the imaging step may include: a) sequentially interrogating the tissue specimen with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and diffuse reflectance signals from the tissue specimen; b) using at least one photodetector to detect the autofluorescence emissions, or the diffuse reflectance signals, or both from the tissue specimen, and to produce photodetector signals representative of the detected said autofluorescence emissions, or the detected said diffuse reflectance signals, or both; c) filtering the light emitted or reflected from the tissue specimen resulting from each said sequential interrogation of the tissue specimen; and d) processing the photodetector signals for each sequential application of the plurality of excitation lights, including producing an image representative of the photodetector signals produced by each sequential application of the plurality of excitation lights.

In any of the aspects or embodiments described above and herein, the filtering step may include filtering the light emitted or reflected from the tissue specimen to selectively pass a portion of the light emitted or reflected from the tissue specimen associated with the one or more biomolecules of interest.

In any of the aspects or embodiments described above and herein, the filtering step may include filtering the light emitted or reflected from the tissue specimen to selectively pass a portion of the light emitted or reflected from the tissue specimen associated with cellular or microstructural morphological information relating to the tissue specimen.

In any of the aspects or embodiments described above and herein, the tissue specimen may be an ex-vivo tissue specimen or a tissue biopsy.

According to an aspect of the present disclosure, a method of analyzing a tissue specimen is provided. The method includes producing a plurality of tissue specimen slices from a tissue specimen, imaging each tissue specimen slice of the plurality of tissue specimen slices to produce autofluorescence images acquired at different excitation and emission wavelengths, and/or reflectance images for each respective tissue specimen slice, using data produced during the imaging of each respective tissue specimen slice to identify the presence or absence of a region of interest within that respective tissue specimen slice, selecting a tissue specimen slice identified as having a region of interest, and performing an omics profiling on the selected tissue specimen slice to produce information relating to the tissue specimen.

In any of the aspects or embodiments described above and herein, the imaging step may include: a) sequentially interrogating each said tissue specimen slice with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and diffuse reflectance signals from the tissue specimen; b) using at least one photodetector to detect the autofluorescence emissions, or the diffuse reflectance signals, or both from the respective tissue specimen slice, and to produce photodetector signals representative of the detected said autofluorescence emissions, or the detected said diffuse reflectance signals, or both; c) filtering the light emitted or reflected from the respective tissue specimen slice resulting from each said sequential interrogation of the tissue specimen slice; and d) processing the photodetector signals for each sequential application of the plurality of excitation lights, including producing an image representative of the photodetector signals produced by each sequential application of the plurality of excitation lights.

In any of the aspects or embodiments described above and herein, the tissue specimen slices may be cryosections.

In any of the aspects or embodiments described above and herein, the step of identifying the presence or absence of a region of interest may include selecting a region of interest for a single cell omics profiling, and the step of performing an omics profiling may include performing a single cell omics profiling.

In any of the aspects or embodiments described above and herein, the step of identifying the presence or absence of a region of interest may include selecting a region of interest for a spatial omics profiling, and the step of performing an omics profiling may include performing a spatial single cell omics profiling.

According to an aspect of the present disclosure, a system for analyzing a plurality of tissue specimen slices from a tissue specimen is provided that includes an excitation light unit, at least one photodetector, at least one optical filter, and a system controller. The excitation light unit is configured to selectively produce a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and at least one of the excitation light centered wavelengths is configured to produce diffuse reflectance signals from a respective tissue specimen slice. The system is configured so that the plurality of excitation lights are incident to the respective tissue specimen slice. The at least one photodetector is configured to detect the autofluorescence emissions, or the diffuse reflectance signals, or both from the respective tissue specimen slice as a result of the respective incident excitation light, and produce signals representative of the detected autofluorescence emissions, or the detected diffuse reflectance signals, or both. The at least one optical filter is operable to filter the signals representative of the detected autofluorescence emissions, or the detected diffuse reflectance signals, or both. The system controller is in communication with the excitation light unit, the at least one photodetector, and a non-transitory memory storing instructions. The instructions when executed cause the system controller to: a) control the excitation light unit to sequentially produce the plurality of excitation lights for each respective tissue specimen slice; b) receive and process the signals from the at least one photodetector for each sequential application of the plurality of excitation lights for each respective tissue specimen slice, and produce an image representative of the signals produced by each sequential application of the plurality of excitation lights for each respective tissue specimen slice; c) analyze each respective tissue specimen slice using a plurality of the images to identify the presence or absence of a region of interest in each respective tissue specimen slice; d) select a tissue specimen slice identified as having a region of interest; and e) perform an omics profiling on the selected tissue specimen slice to produce information relating to the tissue specimen.

In any of the aspects or embodiments described above and herein, the excitation light unit may include a plurality of excitation light sources. Each excitation light source may be configured to produce one of the excitation lights centered on the wavelength distinct from the respective centered wavelength of the other respective excitation lights.

In any of the aspects or embodiments described above and herein, the system may further include a filter arrangement configured to filter the light emitted or reflected from the tissue specimen resulting from each sequential application of the plurality of excitation lights from each of the plurality of excitation light sources.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a flow chart illustrating a present disclosure embodiment.

FIG. 2 is a diagrammatic illustration of an optical system embodiment according to the present disclosure.

FIG. 3 is a table of excitation/illumination wavelengths versus reflectance/fluorescence wavelengths.

FIG. 4 is a graph of fluorescence intensity versus fluorescence emission wavelength, illustrating diagrammatic representations of biomolecule curves.

FIG. 5 is a flow chart illustrating a present disclosure embodiment.

FIG. 6 is a flow chart illustrating a present disclosure embodiment.

FIG. 7 is a flow chart illustrating a present disclosure embodiment.

### DISCLOSURE OF THE INVENTION

Aspects of the present disclosure include a label-free, non-contact and non-invasive optical approach operable to identify one or more diagnostically/pathologically relevant sections on a tissue specimen on which the omics including spatial genomics can be profiled. The present disclosure permits a use of omics approaches in an improved manner to decipher comprehensive molecular and genomic information and insights.

The biomolecules present in different tissues provide discernible and repeatable autofluorescence [1-3] and reflectance [4] spectral patterns. The endogenous fluorescence signatures offer useful information that can be mapped to the functional, metabolic and morphological attributes of a biological specimen, and have therefore been utilized for diagnostic purposes. Biomolecular changes occurring in the cell and tissue state during pathological processes and disease progression result in alterations of the amount and distribution of endogenous fluorophores and form the basis for classification. Tissue autofluorescence (AF) has been proposed to detect various malignancies including cancer by measuring either differential intensity [5] or lifetimes of the intrinsic fluorophores [6]. Biomolecules such as tryptophan, collagen, elastin, nicotinamide adenine dinucleotide (NADH), flavin adenine dinucleotide (FAD), porphyrins, etc. present in tissue provide discernible and repeatable autofluorescence spectral patterns. While tissue AF has been proposed for cancer detection, there are major limitations for conventional autofluorescence-based diagnosis approaches. For example, traditional AF assays typically use a single excitation wavelength which obviously does not excite all the intrinsic fluorophores present in the tissue. Consequently, traditional AF assays do not effectively utilize the comprehensive and rich biochemical information embedded in the tissue matrix both from cells and the extracellular matrix. As another example, most of the applications involving AF use a fiber probe with single-point measurement capability and these applications are inherently slow. As another example, most of the multispectral AF approaches use a complex artificial intelligence/machine learning (AI/ML) algorithm as a black box and therefore lack an interpretability aspect of the classification required for the surgeons and regulatory bodies. Aspects of the present disclosure address the interpretability concerns and provide a potentially transformative tissue analysis tool by utilizing biomolecule/biochemical and tissue microstructural information encoded in AF and reflectance images.

For omics-based tissue profiling, in most cases, a small part of a tissue specimen is used. Considering the tissue heterogeneity, the aforesaid small part of the tissue specimen is not always representative of the entire tissue specimen and therefore are potentially subject to inaccurate molecular and genomic descriptions of the tissue specimen.

The present disclosure is a novel optical spectroscopy-based tissue analysis approach that uses AF images acquired at different excitation and emission wavelengths, and/or reflectance images to permit efficient application of accurate omics measurements by identifying pathological and diagnostic tissue regions. The AF imaging allows the identification of relevant regions of interest (ROIs) that can be used for subsequent omics profiling.

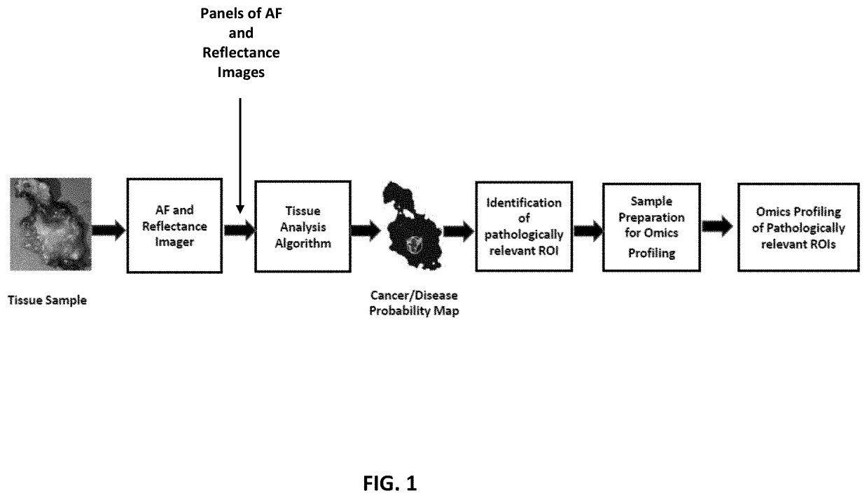

FIG. 1 shows a flow chart of a present disclosure AF-enabled omics profiling methodology embodiment. Freshly excised or formalin-fixed paraffin-embedded (FFPE) tissue is imaged by an AF and reflectance imaging system. The pathologically or diagnostically relevant regions of the tissue specimen are highlighted and registered. The omics measurements are performed from the AF-highlighted ROIs to elucidate relevant information, including DNA or molecular descriptors.

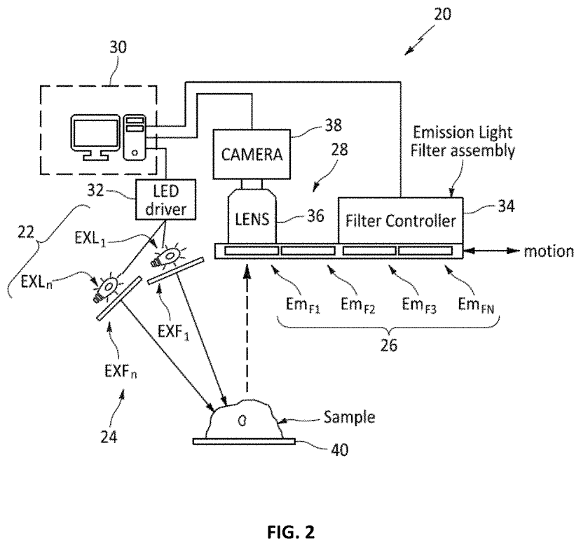

FIG. 2 illustrates a non-limiting example of a system for producing AF and reflectance images. The system includes an excitation light unit, one or more optical filters, one or more photodetectors, and a system controller. In some embodiments, the system may include other components such as one or more of a filter controller, a tunable optical filtering device, a scanning device, an optical switch, an optical splitter, and the like.

The excitation light unit is configured to produce excitation light centered at a plurality of different wavelengths. As will be detail below, the term “excitation light unit” as used herein is not limited to a light source configured to produce AF emissions but is also able to produce reflectance signal. Examples of an acceptable excitation light source include lasers and light emitting diodes (LEDs) each centered at a different wavelength, or a tunable excitation light source configured to selectively produce light centered at respective different wavelengths, or a source of white light (e.g., flash lamps) that may be selectively filtered to produce the aforesaid excitation light centered at respective different wavelengths. The present disclosure is not limited to any particular type of excitation light unit. The wavelengths produced by the excitation light unit are typically chosen based on the photometric properties associated with one or more biomolecules of interest. Excitation light incident to a biomolecule that acts as a fluorophore will cause the fluorophore to emit fluorescent light at a wavelength longer than the wavelength of the excitation light; i.e., via AF. Tissue may naturally include certain fluorophores such as tryptophan, collagen, elastin, nicotinamide adenine dinucleotide (NADH), flavin adenine dinucleotide (FAD), porphyrins, and the like. Biomolecular changes occurring in the cell and tissue state during pathological processes and as a result of disease progression often result in alterations of the amount and distribution of these endogenous fluorophores. Hence, diseased tissues such as cancerous tissue, due to the marked difference in cell-cycle and metabolic activity can exhibit distinct intrinsic tissue AF, or in other words an “AF signature” that is identifiable. Embodiments of the present disclosure may utilize these AF characteristics/signatures to identify regions of diseased tissue such as cancerous tissue. Different types of diseased tissue (e.g., different types of cancerous tissue) and diseased tissue of different organs for instance breast and liver cancers may have different biomolecules/biochemicals associated therewith and the present disclosure is not therefore limited to any particular biomolecule or any particular cancer type. Excitation wavelengths are also chosen that cause detectable light reflectance from tissue of interest. The detectable light reflectance is a function of light absorption of the tissue and/or light scattering associated with the tissue (this may be collectively referred to as diffuse reflectance). Certain tissue types or permutations thereof have differing and detectable light reflectance characteristics (“signatures”) at certain wavelengths. Significantly, these reflectance characteristics can provide information beyond intensity; e.g., information relating to cellular or microcellular structure such as cell nucleus and extracellular components. The morphology of a healthy tissue cell may be different from that of an abnormal or diseased tissue cell. Hence, the ability to gather cellular or microstructural morphological information (sometimes referred to as “texture”) provides another tool for determining tissue types and the state and characteristics of such tissue. The excitation light source may be configured to produce light at wavelengths in the ultraviolet (UV) region (e.g., 100-400 nm) and in some applications may include light in the visible region (e.g., 400-700 nm). The excitation lights are chosen based on the absorption characteristics of the biomolecules of interest.

The present disclosure may utilize a variety of different photodetector types configured to sense light and provide signals that may be used to measure the same. Non-limiting examples of an acceptable photodetector include those that convert light energy into an electrical signal such as photodiodes, avalanche photodiodes, a CCD array, an ICCD, a CMOS, or the like. The photodetector may take the form of a camera. As will be described below, the photodetector(s) are configured to detect AF emissions from the interrogated tissue and/or diffuse reflectance from the interrogated tissue and produce signals representative of the detected light and communicate the signals to the system controller.

The system controller is in communication with other components within the system, such as the excitation light source and one or more photodetectors. In some system embodiments, the system may also be in communication with one or more of a: filter controller, a tunable optical filtering device, an optical switch, an optical splitter, and the like as will be described below. The system controller may be in communication with these components to control and/or receive signals therefrom to perform the functions described herein. The system controller may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. The system controller includes or is in communication with one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller may include, or may be in communication with, an input device that enables a user to enter data and/or instructions, and may include, or be in communication with, an output device configured, for example to display information (e.g., a visual display or a printer), or to transfer data, etc. Communications between the system controller and other system components may be via a hardwire connection or via a wireless connection.

Embodiments of the present disclosure may include optical filtering elements configured to filter excitation light, or optical filtering elements configured to filter emitted light (including reflected light), or both. Each optical filtering element is configured to pass a defined bandpass of wavelengths associated with an excitation light source or emitted/reflected light (e.g., fluorescence or reflectance), and may take the form of a bandpass filter. In regard to filtering excitation light, the system may include an independent filtering element associated with each independent excitation light source or may include a plurality of filtering elements disposed in a movable form (e.g., a wheel or a linear array configuration) or may include a single filtering element that is operable to filter excitation light at a plurality of different wavelengths, or each excitation light source may be configured to include a filtering element, or the like. In regard to filtering emitted light, the system may include a plurality of independent filtering elements each associated with a different bandwidth or may include a plurality of filtering elements disposed in a movable form or may include a single filtering element that is operable to filter emitted/reflected light at a plurality of different wavelengths, or the like. The bandwidth of the emitted/reflected light filters are typically chosen based on the photometric properties associated with one or more biomolecules of interest. Certain biomolecules may have multiple emission or reflectance peaks. The bandwidth of the emitted/reflected light filters are typically chosen to allow only emitted/reflected light from a limited portion of the biomolecule emission/reflectance response; i.e., a portion of interest that facilitates the analysis described herein. The exemplary system embodiment shown in FIG. 2 illustrates a non-limiting example of optical filtering. In some embodiments, the system may include a tunable bandpass filter that is controllable to provide a plurality of different bandwidth filtration modes. In certain embodiments, the excitation filter may be disposed or integrated as a part of excitation light source. For example, the LED or other light source can be coated with a material to allow desired bandpass.

The exemplary present disclosure system 20 diagrammatically illustrated in FIG. 2 includes an excitation light source 22, an excitation light filter arrangement 24, an emission/reflectance light filter assembly 26, a photodetector arrangement 28, and a system controller 30. The excitation light source 22 includes a plurality of independent excitation light sources (e.g., EXL₁ . . . EXLₙ, where “n” is an integer greater than one), each operable to produce an excitation light centered at a particular wavelength and each centered on an excitation wavelength different from the others. The independent excitation light sources are directly or indirectly in communication with the system controller 30. In this example, the independent excitation light sources are UV LEDs. As described above, the wavelengths produced by the independent excitation light sources are chosen based on the photometric properties associated with biomolecules/tissue types of interest. The LEDs are in communication with an LED driver 32 that may be independent of the system controller 30 or the functionality of the LED driver 32 may be incorporated into the system controller 30. The excitation light filter arrangement 24 shown in FIG. 2 includes an independent bandpass filter (EXF₁ . . . EXFₙ) for each excitation light source and the bandwidth filter properties for each independent bandpass filter are tailored for the respective excitation light source with which it is associated. In alternative embodiments the system 20 may be configured without an excitation light filter arrangement, or each excitation light source may have an incorporated filter element, or the system 20 may include an excitation filter arrangement with a movable filter element (e.g., a wheel, linear array, etc.), or may include a single filtering element that is operable to filter excitation light at a plurality of different wavelengths. The system 20 embodiment diagrammatically shown in FIG. 2 includes an emission light filter assembly 26 having a filter controller 34 and a linear array of bandpass filters (e.g., Em_{F1}, Em_{F2} . . . Em_{FN}). The filter controller 34 is configured to selectively position each respective bandpass filter in a light path between the tissue specimen (i.e., the source of the emitted/reflected light) and the photodetector arrangement 28 to permit filtering of the emitted/reflected light prior to detection by the photodetector arrangement 28. The filter controller 34 may be in communication with the system controller 30, or the filter controller 34 functionality may be incorporated into the system controller 30. As stated above, the bandwidth of the respective bandpass filters for the emitted/reflected light are typically chosen based on the photometric properties associated with one or more biomolecules of interest; e.g., to allow only emitted/reflected light from a limited portion of the biomolecule emission/reflectance response that is of interest to facilitate the analyses described herein. The photodetector arrangement 28 includes a lens arrangement 36 and a camera 38. The lens arrangement 36 is configurable to suit the application at hand. For example, in some embodiments the lens arrangement 36 may include a single fixed focus lens. In some embodiments, the lens arrangement 36 may be configured to address chromatic dispersion. For example, the lens arrangement 36 may include one or more corrective lenses configured to address aberration/focus as may be desired. In some embodiments, the lens arrangement 36 may be controllable to selectively change lens configurations and is in communication with the system controller 30. The camera 38 is configured to produce signals representative of the sensed emitted light passed through the emission light filter assembly 26. The aforesaid signals may be referred to as an “image” or may be processed into an image. The camera 38 is in communication with the system controller 30.

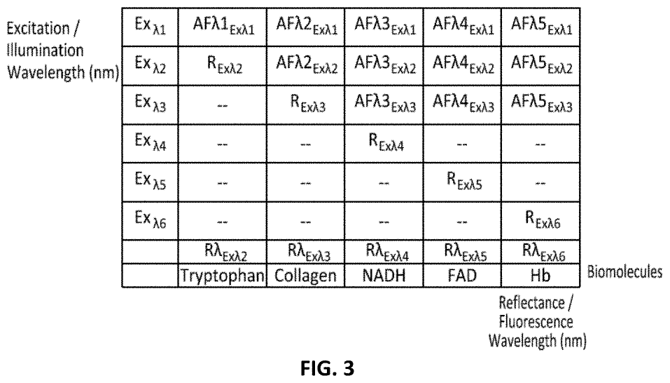

In the operation of the system 30 embodiment diagrammatically shown in FIG. 2, an excised tissue specimen may be placed on a stage 40 or other platform at a position optically aligned with the photodetector arrangement 28. In some instances, the system 20 and/or the tissue specimen may be such that the entirety of the specimen can be imaged without changing the relative positions of the tissue specimen and the system optics. In other instances, wherein the system 20 is not configured to image the entirety of the tissue specimen, the system 20 may be configured to move one or both of the tissue specimen and the system optics relative to one another so multiple regions of the tissue specimen may be imaged; e.g., the tissue specimen may be scanned. The images from the respective regions may subsequently be “stitched” together to form one or more images of the entirety of the tissue specimen. In some instances, the stage 40 may include a plurality of fiduciary markers to facilitate registration between images. The system controller 30 (through stored instructions) is configured to sequentially operate the independent excitation light sources (e.g., EXL₁ . . . EXLₙ). As each excitation light source is operated, the produced excitation light passes through an excitation light filter prior to being incident to the tissue specimen. If a fluorophore of interest is present within the tissue specimen and that fluorophore is responsive to the wavelength of the incident excitation light, the excitation light will cause the fluorophore to produce an AF emission at a wavelength that is different from the excitation wavelength. Excitation light centered on a particular wavelength may produce AF emissions from more than one fluorophore of interest. Referring to the table in FIG. 3, a first excitation wavelength (EXλ1) can produce AF emissions at several different wavelengths (AFλ1_{EXλ1}, AFλ2_{EXλ1}, AFλ3_{EXλ1}, AFλ4_{EXλ1}, AFλ5_{EXλ1}). The same excitation light incident to the tissue specimen may also generate diffuse reflectance signals; i.e., excitation light that is reflected from the tissue specimen. For example, and again referring to the table in FIG. 3, a second excitation wavelength (EXλ2) can produce reflectance signals (R_{EXλ2}) and AF emissions at several different wavelengths (AFλ2_{EXλ2}, AFλ3_{EXλ2}, AFλ4_{EXλ2}, AFλ5_{EXλ2}), a third excitation wavelength (EXλ3) can produce reflectance signal (R_{EXλ3}) and AF emissions at several different wavelengths (AFλ3_{EXλ3}, AFλ4_{EXλ3}, AFλ5_{EXλ4}), and so on. The emission/reflectance light filter assembly 26 is controlled to coordinate placement of a particular bandpass filter in alignment with the camera 38, which bandpass filter is appropriate for the excitation light source being operated and to produce a limited bandwidth of the emitted/reflected light that is of interest for the analysis at hand; e.g., associated with particular biomolecules of interest. Some amount of the emitted light passes through the bandpass filter, is sensed by the camera 38, and the camera 38 produces signals representative of the sensed emitted/reflected light. The aforesaid signals may be referred to as an image or may be processed into an image. In some applications, an excitation wavelength may be chosen only for AF emissions of interest (e.g., EXλ1 in FIG. 3), and/or an excitation wavelength may be chosen only for diffuse reflectance signals of interest (e.g., EXλ4, EXλ5, and EXλ6 in FIG. 3). The above-described process may be repeated until the specimen has been examined using all of the desired wavelengths of excitation light. As will be detailed below, the respective images may be used to collectively identify biomolecules/tissue types of interest with a desirable degree of specificity and sensitivity.

It should be noted that the present disclosure system embodiment diagrammatically illustrated in FIG. 1 is provided as a non-limiting illustration. System 20 embodiments may include various other system components such as additional optical filters; e.g., to limit optical interference of other scattered light, or to block excitation light from a detection path, or for other optical function, and any combination thereof.

In some system 20 embodiments, a tunable excitation light source configured to selectively produce light centered at a plurality of different wavelengths as an alternative to the plurality of AF excitation light sources. The tunable excitation light source may be operated to sequentially produce each of the respective excitation wavelengths.

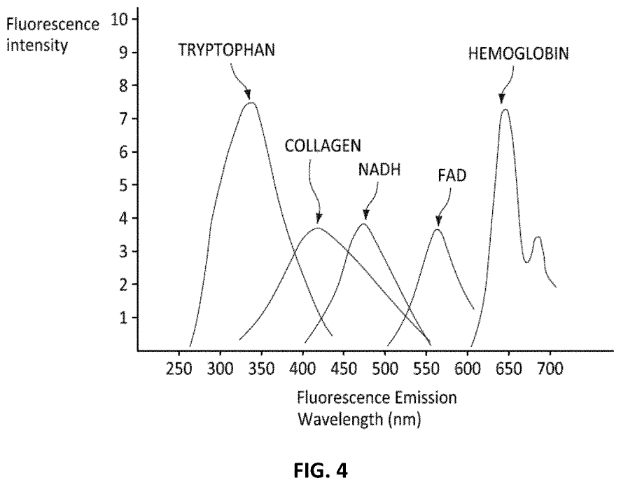

In the system 20 embodiments described above and others, the signals (i.e., image) representative of the emitted light (AF and/or reflectance) captured by the photodetector arrangement 28 (e.g., camera or plurality of photodetectors) for each excitation light wavelength collectively provide a mosaic of information relating to the tissue specimen. The chart shown in FIG. 3 illustrates an exemplary scenario wherein five (5) different excitation light sources, each centered on a different wavelength (i.e., Ex_{λ1}, Ex_{λ2}, Ex_{λ3}, Ex_{λ4}, Ex_{λ5}, and Ex_{λ6} nm), are used within the system 20. Depending on the presence of certain fluorophores within the tissue specimen, the first excitation wavelength (i.e., Exu) may produce AF emissions of interest at five (5) different wavelengths (AFλ1_{Exλ1}, AFλ2_{Exλ1}, AFλ3_{Exλ1}, AFλ4_{Exλ1}, AFλ5_{Exλ1}), and the second excitation wavelength (i.e., Ex_{λ2}) may produce AF emissions of interest at four (4) different wavelengths (AFλ2_{Exλ2}, AFλ3_{Exλ2}, AFλ4_{Exλ2}, AFλ5_{Exλ2}), and so on. The second excitation wavelength (i.e., Ex_{λ2}) may also produce a reflectance image at this wavelength (R_{Exλ2}) that is a useful indicator of the presence or absence of certain tissue types within the tissue specimen. The Ex_{λ4}, Ex_{λ5}, and Ex_{λ6} excitation wavelengths may not be used to produce AF emissions of interest, but each may be used to produce a reflectance image of interest (i.e., R_{Exλ4}, R_{Exλ5}, R_{Exλ6}). As can be seen from the example shown in FIG. 4, the six (6) excitation wavelengths (i.e., Ex_{λ1}, Ex_{λ2}, Ex_{λ3}, Ex_{λ4}, Ex_{λ5}, and Ex_{λ6} nm) may be used to produce seventeen emitted light images (AFλ1_{Exλ1}, AFλ2_{Exλ1}, AFλ3_{Exλ1}, AFλ4_{Exλ1}, AFλ5_{Exλ1}, R_{Exλ2}, AFλ2_{Exλ2}, AFλ3_{Exλ2}, AFλ4_{Exλ2}, AFλ5_{Exλ2}, R_{Exλ3}, AFλ3_{Exλ3}, AFλ4_{Exλ3}, AFλ5_{Exλ3}, R_{Exλ4}, R_{Exλ5}, R_{Exλ6}) that may be used collectively to identify biomolecule/tissue types of interest with a desirable degree of specificity and sensitivity. It should be noted that the number of excitation wavelengths, the number of reflectance wavelengths, the biomolecule, and the particular AF emissions selected, and reflectance emissions indicated in FIG. 3 are provided to illustrate the present disclosure, and the present disclosure is not limited to this example. For example, the analysis of different types of cancer or other diseased tissue may benefit from fewer or more excitation wavelengths, different biomolecule, etc.

The integrated information provided by the aforesaid emitted light images provide distinct benefits in the process of identifying biomolecule/tissue types of interest with a desirable degree of specificity and sensitivity. As can be seen from FIG. 4, AF emissions are produced in a peaked band with an intensity value that is centered on a particular wavelength. Hence, AF emissions centered on a particular wavelength will include AF emissions not only on the peak wavelength but also on adjacent wavelengths albeit at a lesser intensity. As can also be seen in FIG. 4, the biomolecule/fluorophores of interest (e.g., tryptophan, collagen, NADH, FAD, hemoglobin, etc.) have characteristic AF intensity curves with a peak centered on a wavelength but also including lesser intensities at wavelengths adjacent the peak wavelength. The AF intensity curves of some of the biomolecules may overlap to a degree. As a result, AF emissions at a particular wavelength within the overlap region may be a product of AF emissions from a first biomolecule or from a second biomolecule and are likely not dispositive by themselves of either biomolecule. As indicated above, at least some biomolecules of interest also have reflectance curves (indicating the amount of light reflectance which is a function of light absorption of the tissue and light scattering within the tissue) with a peak centered on a peak wavelength but also including lesser intensities at wavelengths adjacent the peak wavelength. The reflectance curves of some of the biomolecules may also overlap to a degree. As a result, reflectance at a particular wavelength within the overlap region may be a product of reflectance from a first biomolecule or from a second biomolecule and is likely not dispositive by itself of either biomolecule. In addition, as indicated above, reflectance images can also provide cellular or tissue microstructural information that can be used as an additional tool for determining tissue types and the state of such tissue. The collective information provided by the aforesaid plurality of emitted/reflected light images produced by the present disclosure system 20, however, provides distinct information at different excitation wavelengths that can be used to identify biomolecule/tissue types with a desirable degree of specificity and sensitivity. In some embodiments, the system controller 30 (via stored instructions) may utilize a stored empirical database during the analysis of the tissue specimen. A clinically significant number of stored AF and/or reflectance images of known tissue types (e.g., adipose, cancerous tissue, benign tissue, etc.) may be used to comparatively analyze the emitted light images (AF and/or reflectance) collected from the tissue specimen at the various different excitation wavelengths. The aforesaid analysis may utilize one or more stored algorithms, and those algorithms may apply weighing factors, or corrective factors, or the like. In some embodiments, reflectance signals/images may be used directly in a classifier and/or to correct AF images.

FIG. 1 shows a flow chart of a present disclosure AF-enabled omics profiling methodology embodiment. In the initial steps, a freshly excised or formalin-fixed paraffin-embedded (FFPE) tissue specimen is imaged using a system for producing AF and reflectance images like that described herein (“AF/Reflectance Imaging System”). PCT Patent Application No. PCT/US2021/050991, entitled “Multi-Spectral Imager for UV-Excited Tissue Autofluorescence Mapping”, discloses AF/Reflectance imaging systems that may be used alternatively. PCT Patent Application No. PCT/US2021/050991 is hereby incorporated by reference in its entirety. The AF/Reflectance Imaging System may be used to map sections, or all, of the tissue specimen to identify pathologically relevant regions of interest (ROI). More specifically, the AF/Reflectance Imaging System is capable of producing data based on AF and/or reflectance images indicative of the type of tissue (e.g., adipose, cancerous tissue, benign tissue, etc.) and therefore whether the tissue is normal (e.g., “healthy”) tissue or abnormal tissue, and if abnormal the data produced from the images may provide more specific information regarding the type of the malignancy and possibly the grade or stage of the malignancy. The AF/Reflectance Imaging System described above provides an efficient and rapid means for identifying ROIs that overcomes many limitations associated with conventional autofluorescence-based diagnosis approaches.

As indicated herein, omics-based tissue profiling typically only utilizes a small part of a tissue specimen. Considering the tissue heterogeneity, the aforesaid small part of the tissue specimen is not always representative of the entire tissue specimen and therefore are potentially subject to inaccurate molecular and genomic descriptions of the tissue specimen. The present disclosure overcomes the potential limitations of currently known omics-based tissue profiling techniques of which we are aware, by initially identifying tissue specimen ROIs using the AF/Reflectance Imaging System, and then subsequently preparing one or more of those ROIs for omics profiling. The omics profiling may include any omics technology, including genomics, transcriptomics, proteomics, and metabolomics, and any combination thereof. Furthermore, the data relating to the ROIs produced using the AF/Reflectance Imaging System may in some instances indicate a plurality of ROIs having the same tissue characteristics; e.g., tissue characteristics indicative of the same type of the malignancy, possibly including information regarding the grade or stage of the malignancy. In this scenario, the information produced using the AF/Reflectance Imaging System may influence the number of “like” ROIs further analyzed by the end user using omics-based tissue profiling techniques. Conversely, the data relating to the ROIs produced using the AF/Reflectance Imaging System may indicate a plurality of ROIs, including one or more ROIs having a first set of tissue characteristics, one or more ROIs having a second set of tissue characteristics, and so on. In this scenario, the information produced using the AF/Reflectance Imaging System may again influence the number of ROIs further analyzed by the end user using omics-based tissue profiling techniques; e.g., the omics-based tissue profiling techniques may be used to further analyze one or more of the ROIs having the first set of tissue characteristics, one or more ROIs having the second set of tissue characteristics, and so on. In this manner, the present disclosure enables a robust collection of tissue data in a very efficient manner.

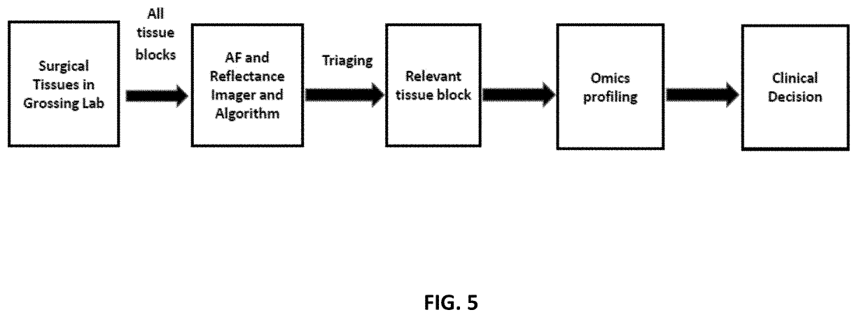

FIG. 5 shows a flow chart of another present disclosure AF-enabled omics profiling methodology embodiment. In the initial steps, the surgical tissue specimen may be prepared in a grossing lab and the tissue specimen blocks or slices may be subsequently imaged and analyzed using the AF/Reflectance Imaging System described above. In this embodiment, the analysis results produced by the AF/Reflectance Imaging System may then be used to triage the tissue specimen blocks. It is typical that not all of the tissue specimen blocks will exhibit the same set of tissue characteristics; i.e., photometric characteristics determined by the AF/Reflectance System. The results produced by the AF/Reflectance Imaging System may be used to segregate those tissue specimen blocks exhibiting tissue characteristics of interest for subsequent omics analysis. In this manner, the burden of the grossing lab to analyze all of the tissue blocks can be significantly reduced, thereby very likely decreasing the amount of time required to produce results and the cost associated therewith. Once the tissue specimen blocks of interest are identified, applicable omics profiling may be performed on those tissue specimen blocks to produce information that can be used in a clinical decision.

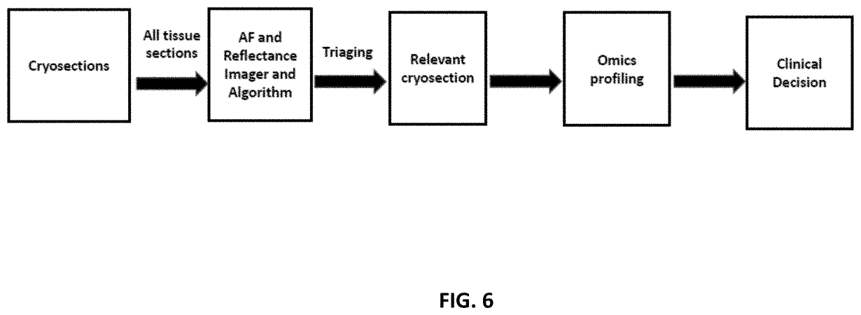

FIG. 6 shows a flow chart of another present disclosure AF-enabled omics profiling methodology embodiment. In this embodiment, the surgical tissue specimen may be processed to produce cryosections. The cryosections may be imaged and analyzed using the AF/Reflectance Imaging System described above. In this embodiment, the analysis results produced by the AF/Reflectance Imaging System may then be used to triage the cryosections. As stated above, it is typical that not all cryosections of a tissue specimen will exhibit the same set of tissue characteristics. The results produced by the AF/Reflectance Imaging System may be used to segregate those cryosections exhibiting tissue characteristics of interest for subsequent omics analysis. In this manner, the burden of the grossing lab to analyze all of the cryosections can be significantly reduced, thereby very likely decreasing the amount of time required to produce results and the cost associated therewith. Once the cryosections of interest are identified, applicable omics profiling may be performed on those cryosections to produce information that can be used in a clinical decision.

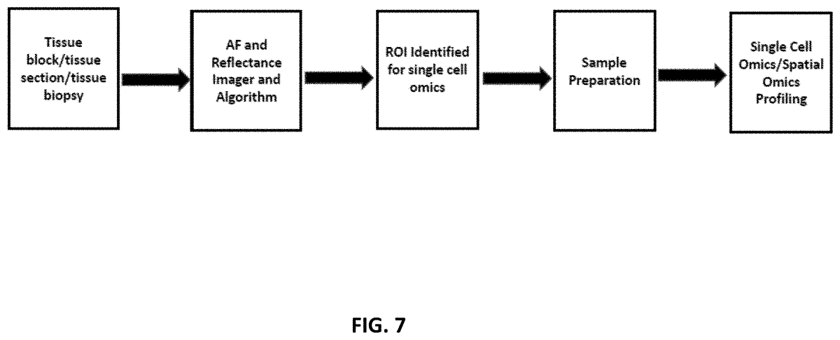

The present disclosure AF-enabled omics profiling methodology embodiments detailed above have been described in terms of tissue specimen analysis. Embodiments of the present disclosure can also provide significant utility for single cell omics and spatial omics profiling. FIG. 7 shows a flow chart of a present disclosure AF-enabled omics profiling methodology embodiment that can be used to provide information relating to single cell omics and/or spatial omics profiling. In this embodiment, a tissue specimen (e.g., a tissue block, a tissue section, a tissue biopsy, or the like) may be imaged and analyzed using the AF/Reflectance Imaging System described above. If a ROI is identified within the tissue specimen based on the information produced using the AF/Reflectance Imaging System, individual cells from the ROI can be isolated and prepared for single cell omics and/or for spatial omics profiling. Single cell omics profiling techniques can be used to produce subcellular components (e.g., DNA, RNA, proteins, and the like) that can provide useful analytical information. The information associated with single cell omics can also be utilized within spatial omics profiling techniques that combine molecular analysis with spatial information relating to the cell's location within the tissue specimen. The information produced using the single cell omics and/or for spatial omics can then be used in a clinical decision.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details. For example, the present disclosure has been described above in terms of analyzing tissue specimens suspected to include cancerous tissue associated with, for example, breast cancer, liver cancer, bladder cancer, colon cancer, and the like. The present disclosure also provides considerable utility with procedures associated with detecting and treating the same. For example, the tissue specimen may be an ex-vivo specimen produced during intraoperative surgery, or the tissue specimen may be a tissue biopsy, or the tissue specimen may be produced and analyzed in conjunction with mammogram for a tissue biopsy diagnosis, or the tissue specimen may be used for triaging surgical specimens in a pathological setting, or the like. The aforesaid are non-limiting examples of applications of the present disclosure.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

The following references are each incorporated by reference in their respective entirety.

### REFERENCES

1. R. A. Schwarz et al., Autofluorescence and diffuse reflectance spectroscopy of oral epithelial tissue using a depth-sensitive fiber-optic probe. Appl Opt 47, 825-834 (2008).
2. W. Zheng, W. Lau, C. Cheng, K. C. Soo, M. Olivo, Optimal excitation-emission wavelengths for autofluorescence diagnosis of bladder tumors. Int J Cancer 104, 477-481 (2003).
3. T. A. Valdez et al., Multiwavelength fluorescence otoscope for video-rate chemical imaging of middle ear pathology. Anal Chem 86, 10454-10460 (2014).
4. T. M. Bydlon, R. Nachabe, N. Ramanujam, H. J. Sterenborg, B. H. Hendriks, Chromophore based analyses of steady-state diffuse reflectance spectroscopy: current status and perspectives for clinical adoption. J Biophotonics 8, 9-24 (2015).
5. M. Wang et al., Autofluorescence Imaging and Spectroscopy of Human Lung Cancer. Applied Sciences 7, 32 (2017).
6. M. Marsden et al., Intraoperative Margin Assessment in Oral and Oropharyngeal Cancer Using Label-Free Fluorescence Lifetime Imaging and Machine Learning. IEEE Transactions on Biomedical Engineering 68, 857-868 (2021).

1. A method of analyzing a tissue specimen, comprising:
imaging a tissue specimen to produce autofluorescence images acquired at different excitation and emission wavelengths, and/or reflectance images;
using data produced during the imaging to identify one or more regions of interest within the tissue specimen; and
performing an omics profiling on the identified one or more regions of interest within the tissue specimen to produce information relating to the tissue specimen.

2. The method of claim 1, wherein the omics profiling utilizes at least one of genomics or transcriptomics.

3. The method of claim 1, wherein the omics profiling utilizes at least one of proteomics or metabolomics.

4. The method of claim 1, wherein the imaging step includes:
sequentially interrogating the tissue specimen with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and diffuse reflectance signals from the tissue specimen;
using at least one photodetector to detect the autofluorescence emissions, or the diffuse reflectance signals, or both from the tissue specimen, and to produce photodetector signals representative of the detected said autofluorescence emissions, or the detected said diffuse reflectance signals, or both;
filtering the light emitted or reflected from the tissue specimen resulting from each said sequential interrogation of the tissue specimen; and
processing the photodetector signals for each sequential application of the plurality of excitation lights, including producing an image representative of the photodetector signals produced by each sequential application of the plurality of excitation lights.

5. The method of claim 4, wherein the filtering step includes filtering the light emitted or reflected from the tissue specimen to selectively pass a portion of the light emitted or reflected from the tissue specimen associated with the one or more biomolecules of interest.

6. The method of claim 4, wherein the filtering step includes filtering the light emitted or reflected from the tissue specimen to selectively pass a portion of the light emitted or reflected from the tissue specimen associated with cellular or microstructural morphological information relating to the tissue specimen.

7. The method of claim 1, wherein the tissue specimen is an ex-vivo tissue specimen or a tissue biopsy.

8. A method of analyzing a tissue specimen, comprising:
producing a plurality of tissue specimen slices from a tissue specimen;
imaging each said tissue specimen slice of the plurality of tissue specimen slices to produce autofluorescence images acquired at different excitation and emission wavelengths, and/or reflectance images for each respective tissue specimen slice;
using data produced during the imaging of each respective tissue specimen slice to identify the presence or absence of a region of interest within that respective tissue specimen slice;
selecting a said tissue specimen slice identified as having a said region of interest; and
performing an omics profiling on the selected tissue specimen slice to produce information relating to the tissue specimen.

9. The method of claim 8, wherein the omics profiling utilizes at least one of genomics, transcriptomics, proteomics or metabolomics.

10. The method of claim 8, wherein the imaging step includes:
sequentially interrogating each said tissue specimen slice with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and diffuse reflectance signals from the tissue specimen;
using at least one photodetector to detect the autofluorescence emissions, or the diffuse reflectance signals, or both from the respective tissue specimen slice, and to produce photodetector signals representative of the detected said autofluorescence emissions, or the detected said diffuse reflectance signals, or both;
filtering the light emitted or reflected from the respective tissue specimen slice resulting from each said sequential interrogation of the tissue specimen slice; and
processing the photodetector signals for each sequential application of the plurality of excitation lights, including producing an image representative of the photodetector signals produced by each sequential application of the plurality of excitation lights.

11. The method of claim 10, wherein the filtering step includes filtering the light emitted or reflected from the respective tissue specimen slice to selectively pass a portion of the light emitted or reflected from the respective tissue specimen slice associated with the one or more biomolecules of interest.

12. The method of claim 10, wherein the filtering step includes filtering the light emitted or reflected from the respective tissue specimen slice to selectively pass a portion of the light emitted or reflected from the respective tissue specimen slice associated with cellular or microstructural morphological information relating to the respective tissue specimen slice.

13. The method of claim 8, wherein the tissue specimen slices are cryosections.

14. The method of claim 8, wherein the step of identifying the presence or absence of a said region of interest includes selecting a said region of interest for a single cell omics profiling; and
wherein the step of performing a said omics profiling includes performing a said single cell omics profiling.

15. The method of claim 8, wherein the step of identifying the presence or absence of a said region of interest includes selecting a said region of interest for a spatial omics profiling; and
wherein the step of performing a said omics profiling includes performing a said spatial single cell omics profiling.

16. A system for analyzing a plurality of tissue specimen slices from a tissue specimen, comprising:
an excitation light unit configured to selectively produce a plurality of excitation lights, each said excitation light centered on a wavelength distinct from the centered wavelength of the other said excitation lights, wherein at least one of the excitation light centered wavelengths is configured to produce autofluorescence emissions from one or more biomolecules of interest, and at least one of the excitation light centered wavelengths is configured to produce diffuse reflectance signals from a respective tissue specimen slice, the system configured so that the plurality of excitation lights are incident to the respective tissue specimen slice;
at least one photodetector configured to detect the autofluorescence emissions, or the diffuse reflectance signals, or both from the respective tissue specimen slice as a result of the respective incident excitation light, and produce signals representative of the detected said autofluorescence emissions, or the detected said diffuse reflectance signals, or both;
at least one optical filter operable to filter the signals representative of the detected said autofluorescence emissions, or the detected said diffuse reflectance signals, or both;
a system controller in communication with the excitation light unit, the at least one photodetector, and a non-transitory memory storing instructions, which instructions when executed cause the system controller to:
control the excitation light unit to sequentially produce the plurality of excitation lights for each respective tissue specimen slice;
receive and process the signals from the at least one photodetector for each sequential application of the plurality of excitation lights for each respective tissue specimen slice, and produce an image representative of the signals produced by each sequential application of the plurality of excitation lights for each respective tissue specimen slice;
analyze each respective tissue specimen slice using a plurality of the images to identify the presence or absence of a region of interest in each respective tissue specimen slice;
select a said tissue specimen slice identified as having a said region of interest; and
perform an omics profiling on the selected tissue specimen slice to produce information relating to the tissue specimen.

17. The system of claim 16, wherein the excitation light unit includes a plurality of excitation light sources, each said excitation light source is configured to produce one of said excitation lights centered on said wavelength distinct from the respective centered wavelength of the other respective said excitation lights.

18. The system of claim 17, further comprising a first filter arrangement configured to filter the light emitted or reflected from the tissue specimen resulting from each said sequential application of the plurality of excitation lights from each of the plurality of excitation light sources.

19. The system of claim 16, wherein the omics profiling utilizes at least one of genomics, transcriptomics, proteomics or metabolomics.

20. The system of claim 16, wherein the tissue specimen slices are cryosections.
